(19) United States
(12) Patent Application Publication
(10) Pub. No.: US 2011/0316291 A1
(43) Pub. Date: Dec. 29, 2011

(54) Portable Security Shield for Roll-Up Door Rotary Latch

(75) Inventors: Robert Loughlin, Stanton, NJ (US); John Loughlin, Lebanon, NJ (US)

(73) Assignee: Stanton Concepts, L.L.C., Stanton, NJ (US)

(21) Appl. No.: 13/154,547

(22) Filed: Jun. 7, 2011

Related U.S. Application Data
(60) Provisional application No. 61/358,559, filed on Jun. 25, 2010.

(51) Int. Cl. E05B 17/20; E05C 19/12

(52) U.S. Cl. 292/101; 292/346

(57) ABSTRACT

A latching mechanism on a roll-up door in a closed position is protected by a portable shield. The shield, in combination with a floor and the roll-up door protects the latching mechanism from direct impact. The shield is locked into place by a bolt that is positioned below a hub of the latching mechanism. An extension of the shield fits into an opening in the floor or a blocking member in the floor. The bolt is positioned in such a way in the shield that when the shield is in its engaged position the bolt can move only either perpendicular to the door and/or it can rotate about an axis substantially perpendicular to the door. The bolt may be a separate bolt or it may be part of a lock. A kit containing a shield is also provided.

### STATEMENT OF RELATED CASES

The present application claims the benefit of U.S. Provisional Patent Application Ser. No. 61/358,559 filed on Jun. 25, 2010, which is incorporated by reference herein in its entirety.

### BACKGROUND OF THE INVENTION

Aspects of the present invention relate to a lock or a latch of a roll-up door as applied on a truck. More in particular aspects of the present invention relate to a new embodiment of such a lock or latch and protection thereof.

The popular roll up doors found on many trucks are closed with a rotary latch mechanism that are primarily made by Todco® of Marion, Ohio or Whiting® Door Manufacturing Corporation of Akron, N.Y. One is referred to U.S. Pat. No. 3,642,314 issued on Feb. 15, 1972, with inventors Smith and Binns and which is incorporated herein in its entirety, for a detailed description of the Todco® latch.

These latches include a means to secure them in the closed position using a generic padlock and/or a tamper indicative seal. This system has been, for many years, appropriate and adequate for most applications. However, more sophisticated or more forceful attacks may defeat this traditional security and thus render it ineffective.

Accordingly, there is a need to enhance the protection of the basic latch mechanism on roll-up doors, and novel and improved means and methods to improve the security of a latch mechanism on a roll up door are required.

### SUMMARY OF THE INVENTION

In accordance with one embodiment of the present invention, a shield to protect a latch on a roll-up door is provided.

In accordance with an aspect of the present invention an apparatus, a method and a kit are provided to protect a latching mechanism on a roll-up door of a truck.

In accordance with a further aspect of the present invention a portable shield is provided for protecting a latching mechanism attached to a roll-up door which is secured to a deck on a truck, the latching mechanism having an arm that rotates about a hub section and a hook that engages a hole in a deck plate in the truck to secure the roll-up door, comprising a top surface, a rear surface extending down from the top surface, the rear surface having a notched shape sized to fit over the hub section, a side surface extending down from the top surface, the side surface having an opening sized to fit over the arm in the latching mechanism and a front surface extending down from the top surface and having a hole, a first flange and a second flange, each connected to the front surface and perpendicularly extending from the front surface adjacent to the hole in the front surface, the first flange and the second flange having each having a hole; the hole in the first flange being aligned with the hole in the second flange a bolt slidably fitting between the first flange and the second flange so as to be able to enter slide in the hole in the front surface.

In accordance with yet a further aspect of the present invention a portable shield is provided, wherein when the bolt slides inside the shield while the shield covers the latching mechanism, the shield disables the hook from being disengaged from the deck plate.

In accordance with yet a further aspect of the present invention a portable shield is provided, wherein the shield is a single piece.

In accordance with yet a further aspect of the present invention a portable shield is provided, wherein the portable shield fits over the latching mechanism and protects the hook of the latching mechanism engaged with the deck plate from direct impact by an object.

In accordance with yet a further aspect of the present invention a portable shield is provided, wherein the side surface is longer than the front surface so that the side surface can enter a hole in the deck plate.

In accordance with yet a further aspect of the present invention a portable shield is provided, wherein the structure of the front surface further comprises means for guiding the bolt within one or both of the first and second flanges.

In accordance with yet a further aspect of the present invention a portable shield is provided, wherein the structure of the front surface further comprises a lock cylinder to support the bolt, the lock cylinder having an unlocked position and a locked position, the locked position putting the bolt in a position between the hub of the latching mechanism and the deck.

In accordance with yet a further aspect of the present invention a portable shield is provided, further comprising a handle.

In accordance with yet a further aspect of the present invention a portable shield is provided, wherein the shield is made of a metal.

In accordance with another aspect of the present invention a portable shield is provided for protecting a latching mechanism attached to a roll-up door which is secured to a deck on a truck, the latching mechanism having an arm that rotates about a hub section and a hook that engages a hole in a deck plate in the truck to secure the roll-up door, comprising a top surface, a rear surface extending down from the top surface, the rear surface having a notched shape sized to fit over the hub section, a side surface extending down from the top surface, the side surface having an opening sized to fit over the arm in the latching mechanism, and a front surface extending down from the top surface and having a hole, a cylinder lock connected to the front surface and having a bolt that can extend through the hole, the bolt extending farthest into the shield when the cylinder lock is locked.

In accordance with a further aspect of the present invention a lock is provided for securing a roll-up door to a deck, comprising a latching mechanism attached to the roll-up door including a hook, a hub and an arm a deck plate, including an engaging element to capture the hook of the latching mechanism, and a separate and portable shield that is placed in a substantially unmovable and secured position over the latching mechanism with the hook captured by the engaging element, by a bolt supported by a front surface of the shield when the bolt is placed in a locked position so that it extends into the shield and is located between the hub and the deck, and wherein the shield is made removable from the substantially unmovable and secured position by placing the bolt in an unlocked position.

In accordance with yet a further aspect of the present invention a lock is provided, wherein the separate and portable shield in the secured position disables the hook.

In accordance with yet a further aspect of the present invention a lock is provided, wherein the shield includes a notched rear surface that enables the shield to clear the hub when placed in the secured position.

In accordance with yet a further aspect of the present invention a lock is provided, wherein the separate and portable shield comprises a side surface with an opening enabling the separate and portable shield to be moved in the secured position over an arm of the latching mechanism in a locked position and enabling a notched rear surface to be positioned between the roll-up door and an arm of the latching mechanism in the secured position.

In accordance with yet a further aspect of the present invention a lock is provided, wherein the side surface has an extension that enters a hole in the deck plate.

In accordance with yet a further aspect of the present invention a lock is provided, wherein the front surface further comprises a hole to receive the bolt, at least a first flange positioned next to the hole; and wherein the bolt and the at least first flange each have a hole enabled to receive a shackle of a padlock to secure the bolt to the flange.

In accordance with yet a further aspect of the present invention a lock is provided, wherein the front surface further comprises a lock cylinder to support the bolt, the lock cylinder having an unlocked position and a locked position, the locked position putting the bolt in a position between the hub of the latching mechanism and the deck.

In accordance with yet a further aspect of the present invention a lock is provided, further comprising a handle on the separate and portable shield.

In accordance with yet a further aspect of the present invention a lock is provided, wherein the roll-up door is part of a vehicle.

In accordance with another aspect of the present invention a method is provided for locking a roll-up door to a deck, comprising engaging a hook of a locking mechanism on the roll-up door with a capturing element of a deck plate, placing an arm of the locking mechanism in a locked position, placing a portable shield in a secured position over at least a portion of the latching mechanism that contains the hook, wherein a notched rear surface of the portable shield is positioned between the roll-up door and the arm of the latching mechanism, and a side surface of the portable shield is positioned with an opening over the arm of the latching mechanism and placing a bolt supported by a front surface of the portable shield in a locked position between a hub of the latching mechanism and the deck to secure the shield to the latching mechanism.

In accordance with yet another aspect of the present invention a method is provided, wherein the shield disables the hook of the latching mechanism.

In accordance with yet another aspect of the present invention a method is provided, wherein the shield comprises a side surface with an extension that enters a hole in the deck plate.

In accordance with yet another aspect of the present invention a method is provided, wherein the front surface further comprises a hole to receive the bolt, at least a first flange positioned next to the hole; and wherein the bolt and the at least first flange each have a hole enabled to receive a shackle of a padlock to secure the bolt to the front surface.

In accordance with yet another aspect of the present invention a method is provided, wherein the front surface further comprises a lock cylinder to support the bolt, the lock cylinder having an unlocked position and a locked position, the locked position putting the bolt in a position between the hub of the latching mechanism and the deck.

In accordance with a further aspect of the present invention a kit is provided for protecting a latching mechanism on a roll-up door that is secured to a deck, comprising a portable shield, including a rear surface having a notched shape enabling the portable shield to be moved in a position with a bottom edge of the portable shield touching the deck of the truck with the rear surface clearing a hub of the latching mechanism, a side surface having an opening enabling the portable shield to be moved over an arm of the latching mechanism in a locked position and enabling the rear surface to be positioned between the roll-up door and an arm of the latching mechanism, and a front surface with a structure to support a bolt to be positioned in a locked position between the hub of the latching mechanism and the deck of the truck, and packaging material.

In accordance with yet a further aspect of the present invention a kit is provided, further comprising a padlock.

In accordance with yet a further aspect of the present invention a kit is provided, further comprising a key.

### DESCRIPTION OF THE DRAWINGS

FIGS. 1a and 1b illustrate a latch on a roll-up door;

FIGS. 2a, 2b, 2c, 2d, 2e and 2f illustrate a protective shield in accordance with an aspect of the present invention;

FIG. 3 illustrates the use of a bolt in combination with a latch in accordance with an aspect of the present invention;

FIG. 4 illustrates an installed protective shield in accordance with an aspect of the present invention;

FIGS. 5a, 5b and 5c illustrate a portable shield with a cylinder lock in accordance with an aspect of the present invention.

### DESCRIPTION

The present invention provides, among other things, improved protective means to protect and to disable a conventional latch as used on, for example, a roll-up door on a truck. A shield in accordance with an aspect of the present invention, is applied to prevent the door from being opened. This improved protective means may be configured to accept a variety of specific generic padlocks using various shackle configurations, as appropriate to an application thereof. In accordance with one aspect of the present invention the forces directly experienced by a latch during and exposure to attack are substantially minimized by the improved means provided by the apparatus described herein, thereby improving the resistance to such an attack. Another embodiment in accordance with an aspect of the present invention may use an integrated lock element in the shield to provide a simple self-contained unit. These options permit the selection of an appropriate lock mechanism and cylinder for a specific application, and may serve to supplement the basic security of a latch system.

There are no modifications required to a door or to installed generic hardware related to the door to apply aspects of the present invention. A device that implements an aspect of the present invention is preferably portable and easily moved between trucks. In many cases it is desirable to have a record with preferably a time stamp of a door opening or unlocking, preferably with an identification of a person who opened or unlocked the door. It may be desirable to authorize a qualified person to open or unlock a door. In one embodiment of the present invention, the Robotic Key System (RKS) as disclosed in U.S. Pat. No. 7,694,542, issued on Apr. 13, 2010 and U.S. Pat. No. 7,712,342, issued on May 11, 2010 and which are both incorporated herein by reference, is installed in a padlock or a lock related to a roll up door lock system. The use of the RKS system allows a user to manage one or more security aspects of a locking system such as on a roll-up door and enables the creation of an audit trail of records of events.

In accordance with an aspect of the present invention, lock protection is provided by a box like device that is placed over a door latch, such as a rotary latch to enclose the latch. The box like device can, engage both the latch and deck elements. This configuration limits motion of the box-like device in rotation and in translation in the direction of the X, Y, and Z-axes. Removal of the device is prevented when it is retained in a secured position by a blocking element that engages the bottom of the rotary latch. The blocking element secures the device in a fixed position. The result is a system to protect and securely disable the engaged Todco® or Whiting® latch, limiting the motion of the door. Applying this device in accordance with an aspect of the present invention to shield a latch or other locking means makes a roll up door on a truck substantially more secure than the exposed latches now in popular use.

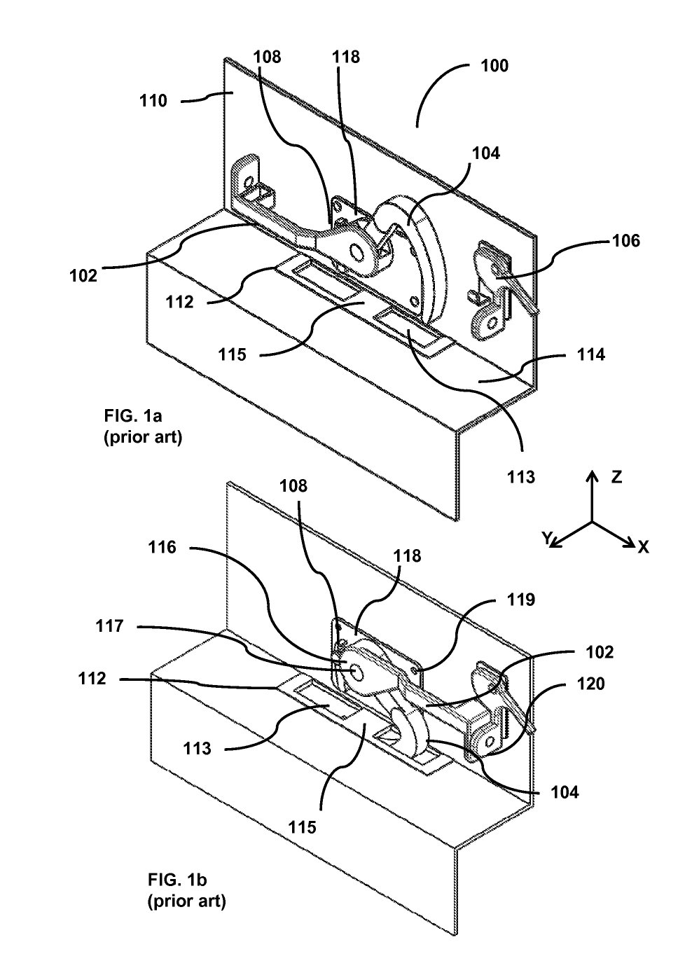

FIG. 1a shows a typical roll-up door rotary latch assembly 100 in its un-latched (un-hooked) state, mounted (installed) on a roll-up door 110, for instance on a vehicle such as a truck. The door 110 is shown closed and only a portion of the door 110 is shown for clarity. The latch assembly 100 has a handle 102, hook 104, hasp 106, a catch 108 and a base plate 118. The vehicle's deck 114 has a plate 112 with openings 113 to accept the hook 104 and a blocking member 115 to capture the hook 104 and block vertical motion of the roll-up door when the hook is captured by blocking member 115. Sometimes this plate 112 is a separate piece that is welded or fastened to the deck 114. In one embodiment 115 may be a separate piece that forms an eye through which the hook 104 can be positioned. In such an embodiment member 115 may stick out above the deck 114 and forms an obstacle which may not be desirable. In another embodiment, the openings 113 and blocking member 115 can be created by cutting the deck 114.

FIG. 1b shows a roll up door latch assembly 100 in its latched state. When the hook 104 is captured by the plate the door 110 cannot be raised. The latch assembly includes a hasp arrangement 120 to accept a padlock and or tamper indicative seal. When a lock or seal is in place the handle 102 cannot be rotated and the hook cannot be disengaged from the deck plate 112.

The base plate 118 of the latch assembly 100 is mounted to the roll-up door 110 with mounting hardware 119. Carriage bolts are commonly used to affix the base plate 118 to the door 110. The base plate 118 has a spindle 117 that provides an axis (Y) for the hub portion 116 of the handle 102 to rotate about. The spindle 117 has a mushroom shape that prevents the handle from becoming separated from the assembly 100. The handle 102 and the hook 104 are separate elements but are designed so that when the handle 102 is rotated counter clockwise about Y it picks up the hook 104 and then both the handle 102 and hook 104 rotate about the spindle 117. When the hook 104 is clear of the blocking member 115, the catch 108 will hold the handle 102 which holds the hook 104 in an un-latched state. To re-latch the latch, the catch 108 is manually released from the handle 102 and when the handle 102 is rotated clockwise and when the door 110 is closed, the hook 104 will rotate into the openings 113 and the latch will be in a latched state.

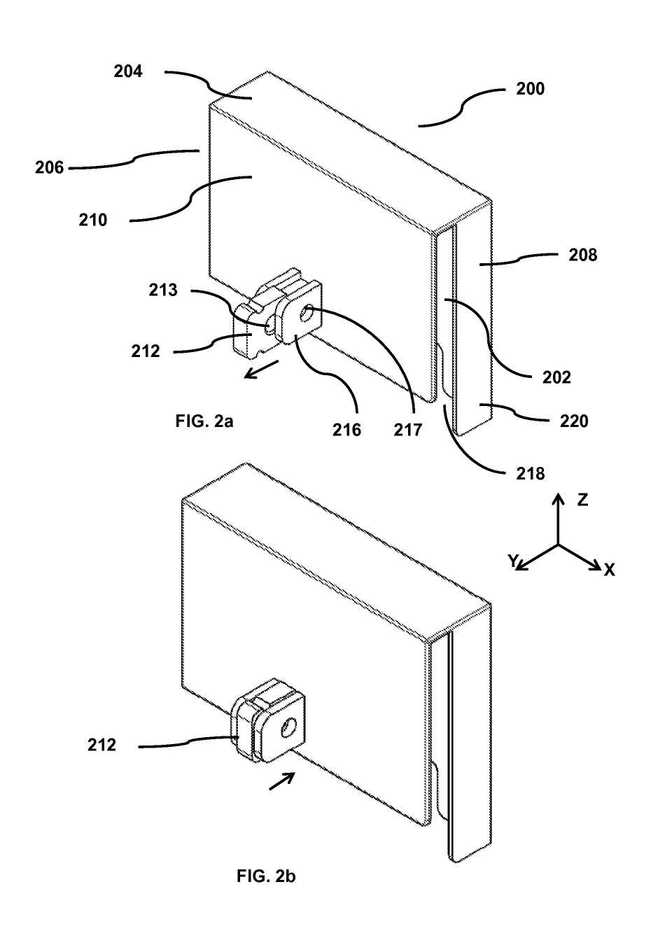

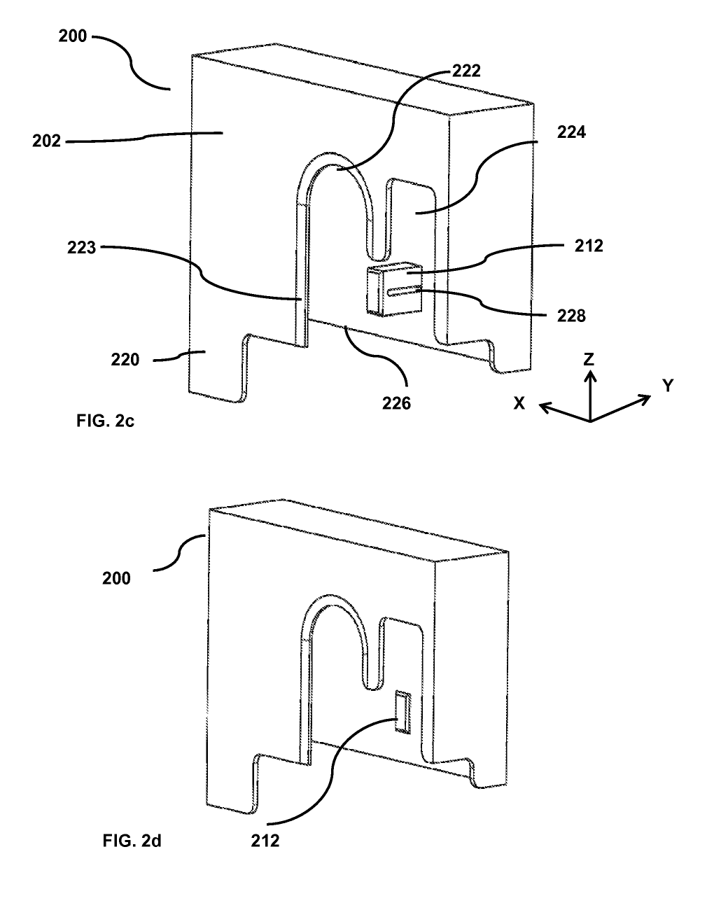

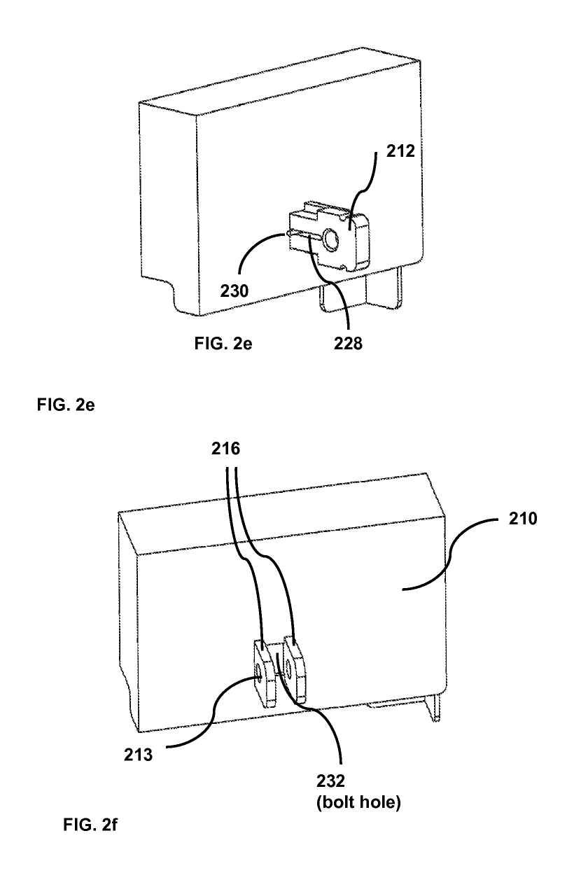

FIG. 2a shows a diagram of one embodiment of a latch shield 200 in accordance with an aspect of the present invention. The latch shield 200 in this diagram shows a blocking bolt 212 in its disengaged state. The latch shield 200 is a structure that may be box like in one embodiment and that has back 202, top 204, left 206, right 208 and front 210 surfaces. The bottom is open, or at least partially open, to allow the shield to be slid over a mounted latch assembly, when the bolt 212 is in its disengaged state. The embodiment shown in diagram in FIG. 2a shows the bolt 212 in a disengaged state. The bolt 212 is configured with a hole 213 that is sized to accept a padlock shackle. The front surface 210 of the shield in FIG. 2a has a hasp flange 216 that is comprised of two members with holes 217 sized and located to accept a padlock shackle.

FIG. 2b shows in diagram the embodiment of the shield 200 of FIG. 2a with the bolt 212 in its engaged position. When the bolt 212 is in its engaged position the holes 217 in the hasp flange 216 and the hole 213 in the bolt 212 are aligned and a shackle of a padlock can be inserted through the aligned holes 217 and 213. When the shackle is in place the bolt 212 cannot be disengaged, and when the padlock is locked the padlock cannot be removed.

The bolt 212 enters the shield 200 through a hole 232 in front surface 210 that is large enough to receive the bolt 212. This is illustrated in FIG. 2f. The hole 232 is located between hasp flanges 216. The hole and or the flanges may be provided with a slot or a ridge to help guide the bolt 212 provided with corresponding guiding features through the hole 232 to be positioned with one end below hub 116. The ridge and slot function on the flange and the bolt may be exchanged so the bolt has the ridge and the flange has the slot, or the bolt has the slot and the flange has the ridge. A means for guiding the bolt along at least one flange is illustrated in FIG. 2e. Of course both flanges may be provided with ridge or slot to guide the bolt with a matching feature. The hole 232 is somewhat obscured by other features in related drawings and it is specifically shown in diagram in FIG. 2f. A hole 217 in flange 216 for receiving a shackle is also shown in FIG. 2b.

It is contemplated that the hasp elements can be optimized to accept generic or specific padlock styles. Contemplated padlocks include but are not limited to U-Shackle, straight shackle, rotary shackle, hidden shackle and hockey puck style padlocks.

The hasp flanges 216 may be welded to the shield. They may also be attached in different ways, such as being riveted or screwed on from the inside of the shield. In a further embodiment, the hasp flanges are removable. For instance, in one embodiment they are fixed perpendicular to a plate with a hole to receive the bolt 212. The shield in such an embodiment is also provided with a hole corresponding to the size and distance of the flanges. To enable the locking of the shield, the flanges protrude from the front surface of the shield, the plate on which the flanges are fixed fitting snugly against the shield. A single flange or multiple flanges, as shown, may be used.

It is further contemplated that the shield may include additional elements to shield the padlock. For instance, the right side of the shield 200 has an extended section 220 to fit into the opening 113 of the plate. This extension 220 extends below the bottom of the front surface of the shield 200 and provides additional registration and constraint of the shield. Extension 220 may be an extension of the side surface 208. Extension 220 may also be an extension of rear surface 202. In a further embodiment extension 220 is an extension of both side surface 208 and rear surface 202. The extensions may have a limited length, for instance less than ½ or even ¼ inch to allow easy insertion without becoming an obstacle for positioning the shield in its protective position. The extensions may be tapered, beveled or even pointing inward to the shield to make insertion easy and providing easy registration. Other surfaces of the shield may also be extended at the bottom at one or more places, over at least part of a bottom of such surface to assist in positioning the shield during installation. It is contemplated that some embodiments may not have this feature. The right side has an opening 218 to allow the latch handle to fit between the front surface 210 and a portion of the right side surface 208.

The term disabled or disabling with regard to the latching mechanism and/or the hook of the latching mechanism is intended to mean: “disabled to be operated” or “disabled to be opened.” The shield, when properly installed, forms a protective cover of the latching mechanism's part that includes the hook 104 in its engaged position with the capturing or blocking member 115 and the hub 116. The shield 200 when in place protects the latch, especially the hub 116 and the hook 104 from being attacked. When the shield 200 is in place, part of the latch, especially the latch arm may 102 be exposed. In one embodiment, the shield 200 is provided with additional surfaces to protect the arm of the latching mechanism from access with a tool to destroy the arm. However, even without such arm protection, but with the shield 200 in place, the latching mechanism is disabled to be operated. That is, the hook 104 is firmly in place and engaged with the capturing element 115. Even when the arm 102 or part thereof of the latching mechanism is destroyed, the hook will remain firmly engaged and will remain protected by the shield 200 and cannot be opened without removing the shield. Accordingly, the shield 200 disables the latching mechanism or disables the latching mechanism from being opened.

When properly placed, the cover that protects the latching mechanism is formed by the shield 200, the deck 114 and the roll-up door 110. To further prevent access to the hook 104 and/or the hub 116 by using extreme force it is preferred that the shield 200 fits fairly tightly to the deck 114 and the door 110 and not create space for a tool to act as a lever. Preferably, the bottom edge of the shield 200 should touch the deck or leave very little room for inserting an edge of a tool. In one embodiment, the bottom edge of the shield 200 has less than 1 mm space with the deck. In another embodiment, the bottom edge of the shield 200 has less than 5 mm space with the deck. In yet a further embodiment, the bottom edge of the shield 200 has less than 1 cm space with the deck.

The shield 200 may be a weldment, a casting or another appropriate type of assembly. The material thickness of each surface may be the same or optimized for each surface's function. It is contemplated that additional flanging may be used to increase strength including increasing bend resistance.

The bolt 212 may have a feature(s) 228 as shown FIG. 2e. (FIG. 2e is shown with the left hasp flange removed for clarity) to constrain its motion to the Y axis and to prevent it from being separated from the shield 200. The feature 228 may be a ridge or a pin with a corresponding feature 230 such as a slot in the hasp flange 216. In a further embodiment, features 228 and 230 may be exchanged, so that 228 is a slot and 230 is a corresponding ridge, for example.

FIG. 2c is a rear view of the shield 200 with the bolt 212 in an engaged, blocking, position, and provides a partial inside view into the shield 200. The back surface 202 has a notch 222 to allow the back of the shield 200 to slide between the latch handle hub 116 and the latch's base plate 118. The notch 222 for the hub 116 may also have a beveled edge 223 to allow the back surface 202 of the shield 200 to fit snuggly between the hub 116 and the base plate 118. The size of the notch 222 is smaller than the distance between the sliding door and the hub 116, so that when the shield 200 is installed and slid down over the latch to a point at which the bottom edge 226 of the shield 200 is in contact or nearly in contact with the deck 114 the shield cannot move in the X or Y direction. The back surface 202 also has a notch 224 to provide clearance for the latch's catch. These notches are dimensioned so that when the shield is installed over the latch assembly the bottom of the shield essentially rests on the deck surface and, for instance, the extension on the right side surface slips into the hook clearance on the hook plate. When the shield 200 is in place and the bolt 212 is in its disengaged, unblocking position the shield can only move vertically, away from the deck. When the bolt 212 is in its engaged, blocking, position the shield 200 cannot move or cannot move substantially in any direction, x, y, z, nor can it rotate nor rotate substantially about any axis.

It is contemplated that additional clearance features may be added to the back surface 202 to clear the base plate's mounting hardware 119 and/or any other fixtures or elements on the deck or the roll-up door that would prevent a tight fit of the shield to the door and/or the deck.

FIG. 2d is a rear view of the shield 200 with a partial view into the shield 200 with the bolt 212 in its retracted or un-engaged (non-blocking) position.

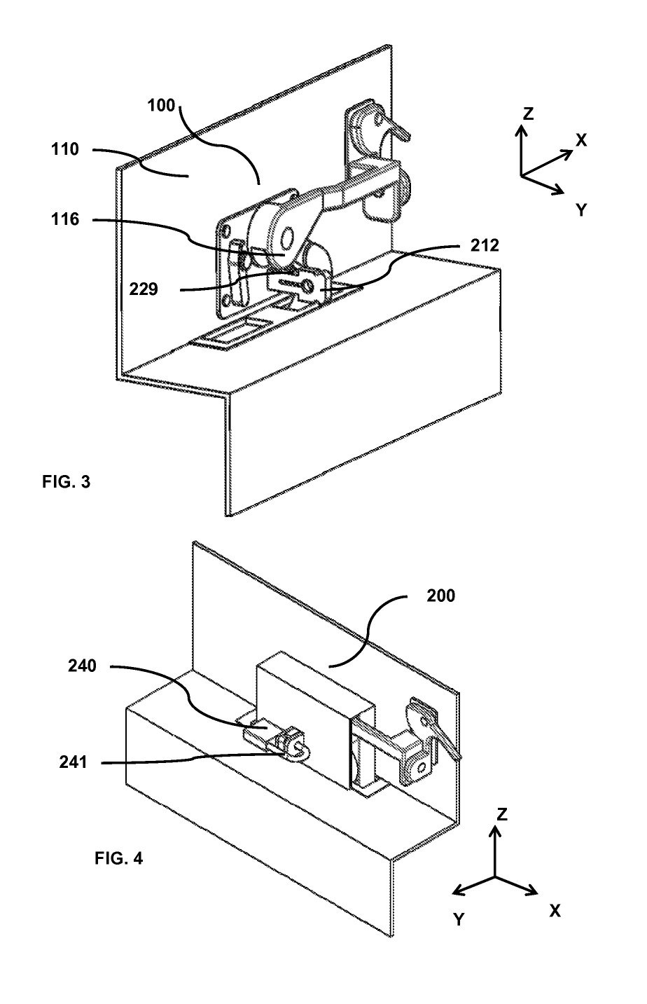

FIG. 3 shows the bolt 212 of a latch assembly 100 installed on a roll-up door 110 in its latched (hooked) state. It shows the bolt 212 of the shield 200 in its engaged (blocking) position, but the shield box 200 is not shown for clarity as to not obstruct the view of the bolt. The edge 229 of the bolt 212 is blocked from upward movement (Z) by the latch hub 116 section in the engaged position, thus preventing the bolt 212 from being move upward. Consequently, the shield 200 is prevented from being moved upward and away from the door and the deck when the hook 104 is engaged with 115, the shield 200 is put in its protecting position and the bolt 212 is engaged by the hub 116.

FIG. 4 shows a latch assembly on a door with the latch latched to the deck and with one embodiment of the latch shield 200 in place. The shield bolt 212 is engaged and a generic padlock 240 with its shackle 241 is engaged through the hasp and bolt holes. The latch hasp does not show a lock or seal in place for clarity. When the shield 200 is in place, critical and vulnerable elements of the latch assembly including the hook 104, hub 116, mounting hardware 118 and 119 and the hook blocking element 115, are inaccessible and protected from a forced attack. This greatly improves the security of the latch on a roll-up door by applying at least one feature in an existing latch (for instance the hub), without modifying the latch.

As previously described, additional features, such as ridges and corresponding slots may be provided on the bolt 212 and hasp flanges 216 to ensure that the bolt 212 slides into a hole in the shield towards the latch in only inward and outward direction (or ‘Y’ direction) without substantial movement in the ‘X’ or the ‘Z’ direction as provided in the Cartesian axes ‘X’, ‘Y’ and ‘Z’ as shown, in for instance, FIGS. 2a and 2b. The flanges of hasp 216 prevent substantial movement of the bolt in the ‘X’ direction. The extension 220 of the side 208 of the shield 200, the rigidity of the material of the shield and the shape of the shield's surfaces to fit against the door 110 and the deck 114 allow the bolt to be positioned correctly relative to the hub 116 and also prevent undesirable movement or openings of the shield relative to the latching mechanism. While an extension 220 is shown for surface 208, the side surface 206 may also be provided with an extension, but is not required.

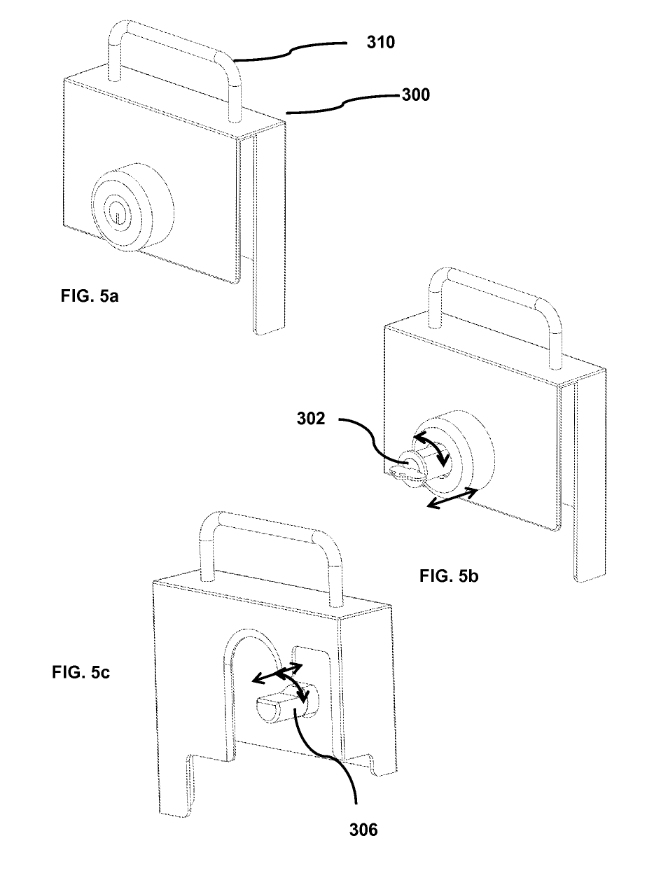

FIGS. 5a, 5b and 5c show in diagram another embodiment of a shield 300 with an integrated lock cylinder 302 in different states. FIG. 5a shows in diagram the shield 300 with an integrated lock cylinder 302 in locked state. The cylinder shown in FIGS. 5a and 5b is a keyed cylinder, however it is contemplated that other types of lock cylinders could be used including but not limited to a Robotic Key System Cylinder (RKS), as disclosed in U.S. Pat. No. 7,021,092 and U.S. Pat. No. 7,694,452, biometric mechanisms and other types of electronic and mechanical locks. The RKS and other smart locks may provide additional access control, alarm functions, and user authorization to open a lock and to create an audit trail.

In a further embodiment an alarm device may be included with the shield assembly. Such an alarm device triggers an alarm when the lock is opened by an unauthorized person, or an unauthorized key. An alarm may also be triggered when the lock or the shield is attacked with unauthorized force. Other types of alarm are also contemplated. For instance, an opening of the lock by itself may trigger an alarm if not an authorized code is provided to a processor or an authority within a limited time frame after the lock opening.

The embodiment shown in FIGS. 5a, 5b and 5c includes a handle 310 to facilitate carrying and installing and un-installing the shield. Any embodiment of a shield 300, as an aspect of the present invention, may include a handle.

FIG. 5b shows the shield 300 with an integrated lock cylinder 302 embodiment with a key in the lock cylinder and the cylinder in its unlocked and non-blocking state. The lock cylinder 302 may or may not retain the key in the cylinder's un-locked state. In this position, the bolt 306 extending from the lock cylinder 302 into the inside of the shield and as shown in FIG. 5c is retracted towards the inside of the shield 300 into a position free of the hub 116 and the shield 300 can be removed from the latch mechanism.

FIG. 5c is a rear view of the shield with an integrated lock embodiment with the bolt 306 in its engaged (blocking) position. When the bolt is in its blocking position the latch handle's hub section 116 blocks vertical movement (Z) of the shield assembly away from the deck. The other features discussed previously prevent all other movement (X, Y and all rotation). In this embodiment the cylinder 302 and bolt 306 are connected, when the lock cylinder is un-locked it can turn and retract in the Y direction, to un-block the assembly. It is anticipated that an integrated lock cylinder could be used that just rotates and includes a blocking element that swings (rotates) between a blocking and non-blocking state.

It has already been noted that a shield as provided herein as an aspect of the present invention can be applied without changing a latch that is to be protected by such a shield. In a further embodiment, a shield as provided herein may be included as part of a kit, such as a security upgrade kit. Such a kit in a further embodiment includes packaging, which may include plastic clamshell packaging, which allows the display of the shield. A kit in a further embodiment includes printed instructions. A kit may also include a padlock, so a purchased kit is ready for direct use. A kit may also include a bolt for securing the shield. In case the shield has a cylinder lock, the kit may have a key to open and close the cylinder lock.

The shield is intended to protect the latch against a direct physical attack. The shield is preferably made of a material that can withstand physical impact for at least some time. In one embodiment, the shield is made of steel or any other appropriate metal. In another embodiment, the shield is made of impact resistant plastic.

In many cases a truck that applies a roll-up door is a delivery truck that makes many stops, wherein a stop may involve opening the door, getting deliveries out of the truck, and closing and locking the roll-up door while a delivery is made. It may be advantageous to provide the shield with an attachment mechanism to the door or to a frame of the door to temporarily store the shield, ready for immediate use, while the roll-up door is in an open position. The door or the frame of the door may be provided with a hook or an attachment to receive the shield, positioned in such a way that the door will not close when the shield is located at the attachment. The extension 220 of surface 208 helps in aligning the shield in an appropriate position for the bolt 212 to be entered through a hole in the shield between the flanges 216 and to be position with one end below the hub 116. Depending on the dimensions of the latch and the plate 112 and opening 113 there may be room for one or more other extensions of the shield. In one embodiment front surface 210 may be provided with an extension over at least a part of the bottom of surface 210 to enter one of openings 113. Such an opening may be beveled to facilitate entering of the extension between the hook and the deck. These may be beveled to facilitate entering between the hook and the deck. This may provide additional alignment and registration of the shield in an engaged position.

A protective shield provided as an aspect of the present invention is shown in for instance FIGS. 2, 4 and 5 as a rectangular box or structure which in one embodiment is relatively thin (in Y dimension or depth) compared to its height (or Z dimension), which has a front and a rear surface, a left side surface and a right side surface and a top surface. A ratio of height to depth in one embodiment is at least 2:1. In a further embodiment a height to depth ratio is greater than 2.5:1. It is contemplated that a height to depth ratio is 1:1 or less may also be used. However, in such embodiments one has to use long bolts, which may not be desirable.

There is no bottom surface shown in the drawings. However, within the practical constraints dictated by the actual latch it is possible, to have at least a partial bottom surface that does not completely close off the bottom.

It has been shown that right side surface 208 has an opening 218 to receive the latch handle. It has also been shown that the shield on the rear surface has a notched opening. The surfaces of the shield in the drawings are connected at the edges at an angle of about 90 degrees, providing the shield structure with a box-like appearance. It should be clear that the surfaces may be connected under angles that are different than 90 degrees. Edges may also be connected in a smooth or rounded way, thus avoiding the rectangular box-like structure of the shield. A surface may be flat, curved or partially curved and partially flat. One may provide the shield with any shape desired, as long it does not prevent the shield from working properly in accordance with one or more aspects of the present invention. Even if other shapes and connections of surfaces are used, the shield herein will still be considered to be a box, with a top surface which may have a handle, a front surface, with either a hole to receive a bolt or with a lock such as a cylinder lock which has at its end a bolt that can rotated in a blocking position under the hub or in an unblocking position away from the hub, a rear surface with notches and shapes that allow the fitting of the shield against the door and around a shape and obstructions formed by the hardware of the latch, a right surface with an opening to receive a handle of the latch, a left surface, and a lack or a substantial lack of a bottom surface, allowing the box to be put around the latch with the latch hook engaged with a member 115 in or on a deck, thus forming a protection cover created by the deck, the door and the shield that makes the latch substantially directly unreachable for a direct impact or processing by a tool. Such a tool may be an impact tool, a cutting tool, a heating tool, a cooling or freezing tool or any other tool that may be applied to remove the hook from its engaged position in an unauthorized way. So even if the shield is not a substantially rectangular box or structure, it may still be called a box or a structure with relevant and identified top side, right side, left side, front side and rear side surfaces and an open or substantially open bottom. The dimensions of the box in one embodiment at the bottom of the right side surface, left side surface, front side surface and rear side surface of the box correspond to a latching deck plate 112. The box encapsulates at least a part of the latch, including a hook that is engaged with a deck plate inside surfaces from the box, the deck and the door. By locking the box or structure to the latch or the truck by a bolt, the latch becomes protected as one cannot remove the shield without unlocking the bolt or the shield.

The box or structure that forms the shield in one embodiment can be a portable, single and inseparable structure. It may be formed by welding, gluing, screwing, riveting, or otherwise combining parts together. In its operational form the shield is one entity and no assembly is required. It can be put in place over the hook in locked position and secured by entering and locking the bolt or by locking a lock that is part of the shield.

The shield provides protection to the latching mechanism without the need for changing the latch or the truck. The shield becomes unmovable or substantially unmovable when locked in place by at least two structural features as described above. A first feature is a bolt inserted through the shield with an end below the hub of the latch or a bolt attached to a lock cylinder that can be rotated in a locked position under the hub. This prevents the shield from being lifted. A second feature is a shape of the rear surface of the shield having a notch and a partially closed rear surface. This allows the rear surface to be placed around the hub and behind the latch handle when the latch is locked. By the shape of the notch it is impossible to move or to substantially move the shield in X or Y direction. The use of an extension on a side surface further restricts movement in X direction. Accordingly, when the shield is placed over the latch in its protective position, it can only be removed by moving it first in the Z direction (lifting it). With a bolt in place under the hub, the shield can not be lifted up or not be substantially lifted up. As the shield cannot be moved in X, Y or Z direction it is in a locked and secured state to protect the latching mechanism.

Preferably, the shield in a secured position has at least one bottom edge of at least either the front, the rear or one of the side surfaces resting on the deck. It is possible in one embodiment that the notch of the rear surface will come to rest on the hub of the latching mechanism before any of the edges will touch the deck. This also allows the shield to be secured to the latching mechanism if the bolt is still between the hub and the deck. In such an embodiment the whole shield may slightly rotate around the hub and allow at least one edge of a rear, front or side surface to touch the deck in a secured position.

The deck plate 112 herein is identified as a separate structure. The deck plate in one embodiment is a separate piece that can be attached to the deck of a truck. For instance, one may create a hole in the deck and attach the deck plate 112 to the deck. This includes a catch 115 for engaging the hook of the latching mechanism. In a further embodiment, one may create two holes in a deck, close but separated by a not removed part 115 of the deck, which thus forms a catch for the hook of the latching mechanism. While this embodiment is a modification of the deck by removal of material without putting addition structure in place, this and similar deck modifications are still considered as deck plates for the purpose of forming an engagement element for the hook of the latching mechanism. One may also in a further embodiment attach a receiving eye to a deck to capture the hook of the latching mechanism. This may require replacing the latching mechanism on the roll-up door to allow the door to be completely closed to the deck when in a locked position. This may also require an adjustment to a size of the shield. However, a protection of a hook of a locking mechanism by a shield in a secured position will still be effective by applying an aspect of the present invention.

In a further embodiment the deck plate 112 (or the deck) only has one hole 113 to receive the hook 104. The latching mechanism and the hook may be so constructed that the hook 104 in a secure position is positioned under element 115. This prevents the door from being opened. In such an embodiment the hook remains under 115 and does not go around it. However, the hook in such embodiment is still captured by element 115.

Embodiments of the invention provided herein protect the hook of the latching mechanism. The arm of the latching mechanism in several embodiments has a flange that aligns with a flange of the hasp 106. Both flanges have a hole that can receive a shackle of a padlock and allows the latching mechanism to be locked by a padlock. The herein provided embodiments of the present invention do not intend to interfere with such a locking of the handle on a hasp. One is still allowed to independently lock the latching mechanism to a hasp, while an embodiment of the present invention protects at least the hook of the latching mechanism from impact by an object. Both protective and securing measures thus can be operated independently to lock and protect the latching mechanism. One can easily see that even if a malfeasant destroys the padlock of the latching arm or the exposed part of the latching arm, the hook remains protected and the door cannot be opened.

As an illustrative example a shield for a latch on a roll-up door in a truck has been described. It is known that lockable roll-up doors are also applied in static applications, such as buildings. Roll-up doors may also be provided in movable structures such as containers. Embodiments of the present invention in structures other than trucks have been contemplated and are explicitly included herein.

Examples of an embodiment of the shield in accordance with an aspect of the present invention are provided in relation to a latching mechanism on a roll-up door, wherein the latching mechanism has a hook that is captured by a deck plate on a deck. It is fully contemplated that the latching mechanism may also be attached to other type of doors, including single panel doors and multi-panel doors. A deck plate or an eye to capture a hook may be part of a wall or a door frame, and is thus not limited to a deck of a truck. In general the examples are provided in an orientation wherein a door is locked and protected with the hook captured by a deck plate on a floor. This is not a required limitation. Doors may be opened and closed with locks in other orientations. For instance a capturing element for a hook may be on the top of a door opening or at a side of a door opening. Gravity may favor the use of a shield on a door secured to a floor. However, other orientations are possible and are fully contemplated.

In accordance with an aspect of the present invention a method is provided for protecting a latching mechanism 100 attached to a door, which may be a roll-up door 110, the latching mechanism 100 including a hook 104 that is captured or engaged by an engaging member 115 attached to or being part of a floor, a deck 114 or a frame, with a portable shield 200, comprising: Engaging the hook 104 of the latching mechanism 100 on the door 110 with the capturing member 115, placing the portable shield 200 in a secured position over at least a portion of the latching mechanism 200 that contains the hook 104 and a hub 116, wherein a notched rear surface 202 of the portable shield 200 is positioned between the door 110 and an arm 102 of the latching mechanism 100, and a side surface 208 of the portable shield 200 is positioned with an opening 218 over the arm 102 of the latching mechanism 100, and placing a bolt 212 or 306 supported by a front surface 210 of the portable shield 200 in a locked position between the hub 116 of the latching mechanism 100 and the deck 114 to secure the shield 200 to the latching mechanism 100.

In a further embodiment the above method is provided, wherein the shield 200 disables the hook 104 of the latching mechanism 100.

In a further embodiment the above method is provided, wherein the shield 200 comprises a side surface 208 with an extension 220 that enters a hole in the deck 114.

In a further embodiment the above method is provided, wherein the front surface 210 further comprises a hole 232 to receive the bolt 212, at least a first flange 216 positioned next to the hole 232, and wherein the bolt 212 and the first flange 216 have a hole 217 and 21 respectively, enabled to receive a shackle of a padlock to secure the bolt 212 to the front surface 210.

In a further embodiment of a method to protect the latching mechanism, the front surface 210 of the shield 200 comprises a cylinder lock as shown in FIG. 5a that supports a bolt 306, wherein the lock cylinder has a locked position and an unlocked position. The locked position putting the bolt 306 in a position between the hub 116 of the latching mechanism 100 and the deck 114.

In a further embodiment of the above method, a bolt supported by a cylinder lock comprises an arm that is rotated in a locked position being between the hub 116 and the deck 114 and can also be rotated from the locked position in an unlocked position wherein the arm is not in a position between the hub 116 and the deck 114.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

We claim:

1. A portable shield for protecting a latching mechanism attached to a roll-up door which is secured to a deck on a truck, the latching mechanism having an arm that rotates about a hub section and a hook that enters a hole in a deck plate in the truck to secure the roll-up door, comprising:
a top surface;
a rear surface extending down from the top surface, the rear surface having a notched shape sized to fit over the hub section;
a side surface extending down from the top surface, the side surface having an opening sized to fit over the arm in the latching mechanism; and
a front surface extending down from the top surface and having a hole;
a first flange and a second flange, each connected to the front surface and perpendicularly extending from the front surface adjacent to the hole in the front surface, the first flange and the second flange having each having a hole; the hole in the first flange being aligned with the hole in the second flange;
a bolt slidably fitting between the first flange and the second flange so as to be able to enter slide in the hole in the front surface.

2. The portable shield as claimed in claim 1, wherein when the bolt slides inside the shield while the shield covers the latching mechanism, the shield disables the hook from being disengaged from the leaving the hole in the deck plate.

3. The portable shield as claimed in claim 1, wherein the shield is assembled as a single piece.

4. The portable shield as claimed in claim 1, wherein the portable shield fits over the latching mechanism and protects the hook of the latching mechanism from direct impact by an object or from other attacks.

5. The portable shield as claimed in claim 1, wherein the side surface is longer than the front surface so that the side surface can enter a hole in the deck plate.

6. The portable shield as claimed in claim 1, wherein the structure of the front surface further comprises means for guiding the bolt within one or both of the first and second flanges.

7. The portable shield as claimed in claim 1, wherein the structure of the front surface further comprises:
a lock cylinder to support the bolt, the lock cylinder having an unlocked position and a locked position, the locked position putting the bolt in a position between the hub of the latching mechanism and the deck.

8. The portable shield as claimed in claim 1, further comprising a handle.

9. The portable shield as claimed in claim 1, wherein the shield is made of a metal.

10. A portable shield for protecting a latching mechanism attached to a roll-up door which is secured to a deck on a truck, the latching mechanism having an arm that rotates about a hub section and a hook that enters a hole in a deck plate in the truck to secure the roll-up door, comprising:
a top surface;
a rear surface extending down from the top surface, the rear surface having a notched shape sized to fit over the hub section;
a side surface extending down from the top surface, the side surface having an opening sized to fit over the arm in the latching mechanism; and
a front surface extending down from the top surface and having a hole;
a cylinder lock connected to the front surface and having a bolt that can extend through the hole, the bolt extending farthest into the shield when the cylinder lock is locked.

11. A lock for securing a roll-up door to a deck, comprising:
a latching mechanism attached to the roll-up door including a hook, a hub and an arm;
a deck plate, including a blocking member to capture the hook of the latching mechanism; and
a separate and portable shield that is placed in a substantially unmovable and secured position over the latching mechanism with the hook secured by the blocking member by a bolt supported by a front surface of the shield when the bolt is placed in a locked position so that it extends into the shield and is located between the hub and the deck, and wherein the shield is made removable from the substantially unmovable and secured position by placing the bolt in an unlocked position.

12. The lock as claimed in claim 10, wherein the separate and portable shield in the secured position disables the hook.

13. The lock as claimed in claim 10, wherein the shield includes a notched rear surface that enables the shield to clear the hub when placed in the secured position.

14. The lock as claimed in claim 10, wherein the separate and portable shield comprises a side surface with an opening enabling the separate and portable shield to be moved in the secured position over an arm of the latching mechanism in a locked position and enabling a notched rear surface to be positioned between the roll-up door and an arm of the latching mechanism in the secured position.

15. The lock as claimed in claim 10, wherein the side surface has an extension that enters a hole in the deck plate.

16. The lock as claimed in claim 10, wherein the front surface further comprises:
a hole to receive the bolt;
at least a first flange positioned next to the hole; and wherein the bolt and the at least first flange each have a hole enabled to receive a shackle of a padlock to secure the bolt to the flange.

17. The lock as claimed in claim 10, wherein the front surface further comprises:
a lock cylinder to support the bolt, the lock cylinder having an unlocked position and a locked position, the locked position putting the bolt in a position between the hub of the latching mechanism and the deck.

18. The lock as claimed in claim 10, further comprising a handle on the separate and portable shield.

19. The lock as claimed in claim 8, wherein the roll-up door is part of a vehicle.
